(19) United States
(12) Patent Application Publication
(10) Pub. No.: US 2021/0201941 A1
(43) Pub. Date: Jul. 1, 2021

(54) MAGNETIC HEAD SLIDER, MAGNETIC HEAD ASSEMBLY AND MAGNETIC DISC DEVICE

(71) Applicants: Kabushiki Kaisha Toshiba, Tokyo (JP); Toshiba Electronic Devices & Storage Corporation, Tokyo (JP)

(72) Inventor: Hiroyuki Hyodo, Yokohama Kanagawa (JP)

(21) Appl. No.: 17/012,310

(22) Filed: Sep. 4, 2020

(30) Foreign Application Priority Data
Dec. 26, 2019 (JP) 2019-236011

(51) Int. Cl. G11B 5/31; G11B 5/60; G11B 5/48

(52) U.S. Cl. CPC G11B 5/3133; G11B 5/4833; G11B 5/6005

(57) ABSTRACT

According to one embodiment, a magnetic head slider includes a slider body, a magnetic recording/reproducing element provided on the slider body, a thermally conductive first protective layer provided on at least a part of a total of air bearing surfaces of the slider body and the magnetic recording/reproducing element, having a thermal conductivity of 200 W/(m·K) or higher and a second protective layer provided on the first protective layer.

### CROSS-REFERENCE TO RELATED APPLICATIONS

This application is based upon and claims the benefit of priority from Japanese Patent Application No. 2019-236011, filed Dec. 26, 2019, the entire contents of which are incorporated herein by reference.

### FIELD

Embodiments described herein relate generally to a magnetic head slider, a magnetic head assembly and a magnetic disc device.

### BACKGROUND

For a protection film of magnetic head sliders, carbon films, having excellent durability against sliding and corrosion are employed, but they entail a drawback of inferior heat resistance. When recording/reproducing, heat is generated around a magnetic head by, for example, heat by a heater for controlling the flying height or heating by the laser beam used in heat assist recording. Thus, there is unsolved drawback of degradation of the carbon protective layer caused by such a heat and degrading of quality of the recording/reproducing device caused by the degradation the carbon protective layer.

### BRIEF DESCRIPTION OF THE DRAWINGS

FIG. 1 is a block diagram illustrating a configuration of a disc drive of the first embodiment.

FIG. 2 is a side view showing a magnetic head and a suspension in the HDD shown in FIG. 1.

FIG. 3 is an enlarged cross section of a head portion of the magnetic head shown in FIG. 2.

FIG. 4 is a perspective diagram schematically showing a recording head in the magnetic head shown in FIG. 3.

FIG. 5 is an enlarged cross section showing an ABS-side end portion of the recording head shown in FIG. 3, taken along a track center.

FIG. 6 is a partially enlarged cross section of the magnetic head shown in FIG. 5.

FIG. 7 is a cross section of another example of a protective layer used in the embodiment.

FIG. 8 is a cross section of still another example of a protective layer used in the embodiment.

FIG. 9 is a graph showing the relationship between the heating temperature of the protective layer used in the embodiment and Id/Ig.

### DETAILED DESCRIPTION

In general, according to one embodiment, a magnetic head slider comprises a slider body, a magnetic recording/reproducing element provided on the slider body, and a multi-layered protective layer provided on at least a part of a total of air bearing surfaces of the slider body and the magnetic recording/reproducing element. The multi-layered protective layer includes a first protective layer provided on at least a part of a total of air bearing surfaces of the slider body and the magnetic recording/reproducing element and a second protective layer provided on the first protective layer. The first protective layer is a thermally conductive protective layer containing a material having a thermal conductivity of 200 W/(m·K) or higher. The second protective layer is a surface protective layer of a material different from that of the first protective layer contains aluminum nitride, which is provided on the air bearing surface of the magnetic head slider.

According to another embodiment, a magnetic head assembly comprises a magnetic head slider comprising a slider body, a magnetic recording/reproducing element provided on the slider body, a multilayered protective layer provided on at least a part of a total of air bearing surfaces of the slider body and the magnetic recording/reproducing element, a suspension with an end in which the magnetic head slider is mounted and an actuator arm connected to an other end of the suspension.

According to still another embodiment, a magnetic disk device comprises a magnetic head assembly which comprises a magnetic head slider comprising magnetic head slider comprising a slider body, a magnetic recording/reproducing element provided on the slider body, a multilayered protective layer provided on at least a part of a total of air bearing surfaces of the slider body and the magnetic recording/reproducing element, and a suspension with an end in which the magnetic head slider is mounted and an actuator arm connected to an other end of the suspension.

According to the embodiments, the protective layer is formed into a multilayered structure, and a thermally conductive protective layer is provided on a slider body side with respect to the outermost surface protective layer. With this structure, heat generated during recording and reproducing is released via the heat-conducting protective layer, and thus degradation of the outermost surface protective layer can be suppressed. With this structure, the degradation of the magnetic recording/reproducing element can be suppressed. Further, a magnetic head having excellent durability can be obtained.

Hereinafter, embodiments will be described with reference to the drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by the same reference numerals and their detailed descriptions may be omitted unless necessary.

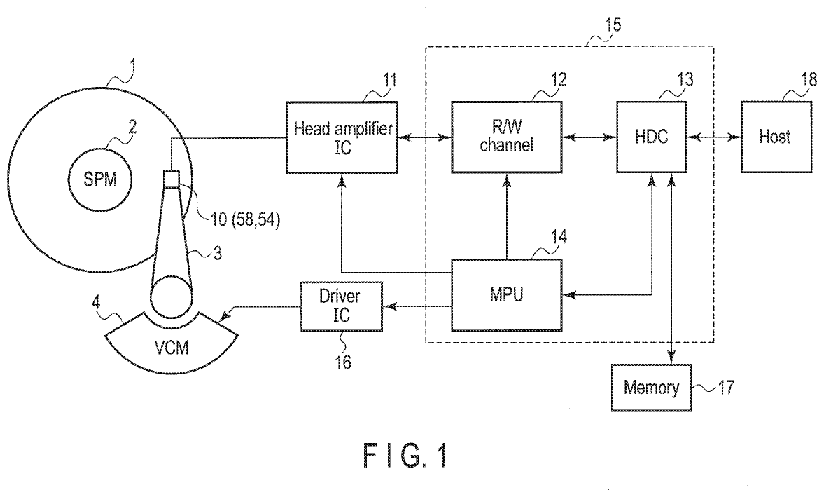

First, with reference to FIG. 1, a configuration of a disc drive, which is a magnetic recording/reproducing device according to the present embodiment will be described.

As seen in FIG. 1, the disc drive is a perpendicular magnetic recording-type magnetic disc device in which a magnetic disk 1 (to be referred to as a disk hereinafter), which is perpendicular magnetic recording medium, and a magnetic head 10 comprising a magnetic flux control layer, which will be described later, are incorporated.

The disk 1 is fixed to a spindle motor (SPM) 2 and attached thereto to be rotatable. The magnetic head 10 is mounted to an actuator 3 and configured to be movable in a radial direction above the disk 1. The actuator 3 is rotated by a voice coil motor (VCM) 4. The magnetic head 10 includes a recording (write) head 58 and a reproducing (read) head 54.

Further, the disc drive comprises a head amplifier integrated circuit (to be referred to as a head amplifier IC hereinafter) 11, a read/write channel (R/W channel) 12, a hard disk controller (HDC) 13, a micro processing unit (MPU) 14, a driver IC 16 and a memory 17. The R/W channel 12, HDC 13 and MPU 14 are incorporated in a controller 15 constituted by an integrated circuit of one chip.

The head amplifier IC 11 includes a circuitry to drive a spin-torque oscillator (STO), which is a magnetic flux control layer, to be described later. Hereinafter, the spin torque oscillator will be referred to as STO. Furthermore, the head amplifier IC 11 includes a driver which supplies a recording signal (write current) corresponding write data supplied from the R/W channel 12 to the recording head 58. Further, the head amplifier IC 11 includes a read amplifier which amplifies a read signal output from the reproducing head 54 and transmits it to the R/W channel 12.

The R/W channel 12 is a signal processing circuit for read/write data. The HDC 13 constitutes an interface between a disc drive and a host 18 and executes transfer control of read/write data.

The MPU 14 is a main control unit of the disc drive and executes servo control necessary to control a read/write operation and alignment of the magnetic head 10. Further, the MPU 14 executes conduction control of the STO of this embodiment. The memory 17 includes a buffer memory formed from a DRAM, a flash memory and the like.

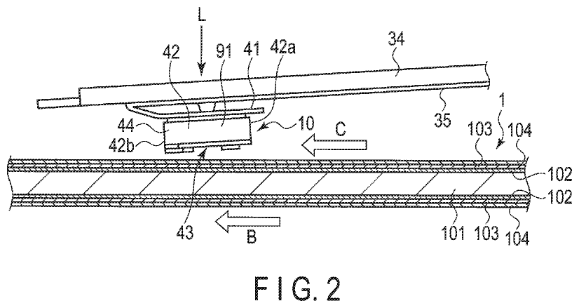

FIG. 2 is a side view showing the magnetic head 10 and a suspension.

As shown in FIG. 2, the magnetic head 10 is configured as a flying head and includes a substantially rectangular parallelepiped slider 42 and a recording/reproducing head portion 44 provided to in an outlet edge (trailing edge) of the slider 42. The magnetic head 10 is fixed to a gimbal spring 41 provided in a distal end portion of the suspension 34. To the magnetic head 10, a head load L towards the surface of the magnetic disk 1 is applied by elasticity of the suspension 34. As shown in FIG. 2, the magnetic head 10 is connected to the head amplifier IC 11 and HDC 13 via a wiring member (flexure) 35 fixed on the suspension 34 and an arm 32.

Next, the configurations of the magnetic disk 1 and the magnetic head 10 will now be described in detail.

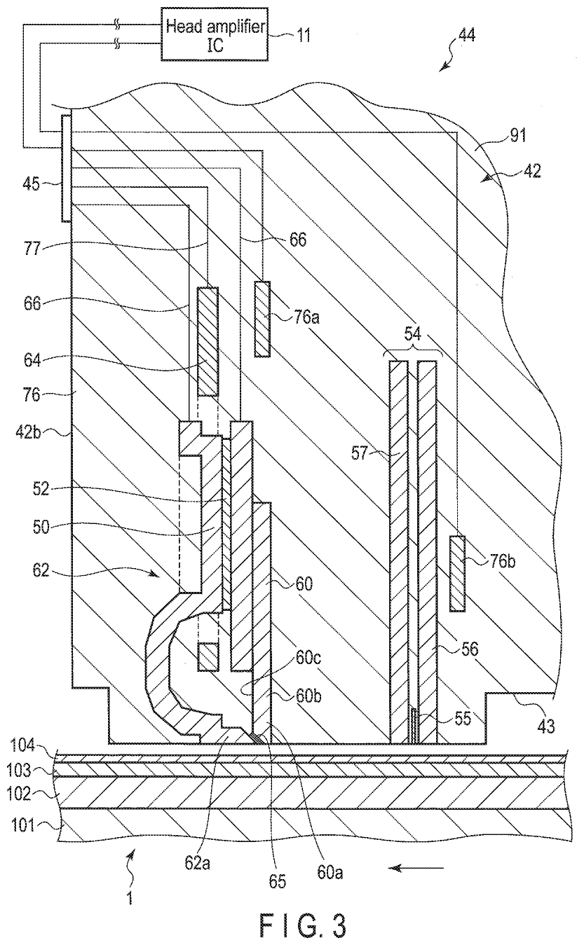

FIG. 3 is an enlarged cross section showing the head portion 44 and the magnetic disk 1 of the magnetic head 10.

As shown in FIGS. 2 and 3, the magnetic disk 1 comprises a substrate 101 formed, for example, into a disk having a diameter of approximately 2.5 inches (6.35 cm) from a nonmagnetic material. On each of the surfaces of the substrate 101, a soft magnetic layer 102 of a material exhibiting soft magnetic properties, as an underlying layer, a magnetic recording layer 103 exhibiting magnetic anisotropy perpendicular to a disk surface on top thereof, and a protective layer 104 on top thereof are laminated in this order. Note that for the magnetic disk 1, a magnetic disk comprising a substrate of size of, for example, approximately 3.5 inches (9.5 cm or 9.6 cm) in diameter can be employed.

A slider body 91 of the slider 42 on which the magnetic head 10 is provided, is formed from a sintered body of, for example, alumina and titanium carbide (Al₂O₃—TiC), and the head portion 44 is formed by laminating thin films one on another. The slider 42 comprises a rectangular disk-facing surface (air bearing surface (ABS)) 43 facing the surface of the magnetic disk 1. The slider 42 flies by air stream C created between the disk surface and the ABS 43 by rotation of the magnetic disk 1. The direction of the air stream C coincides with a rotation direction B of the magnetic disk 1. The slider 42 is disposed in such a manner that a longitudinal direction of the ABS 43 substantially coincides the direction of the air stream C with respect to the surface of the magnetic disk 1.

The slider 42 includes a leading edge 42a located on an inflow side of the air stream C and a trailing edge 42b located on outflow side of the air stream C. On the ABS 43 of the slider 42, a leading step, a trailing step, a side step, a negative pressure cavity, and the like (not shown) are formed.

As shown in FIG. 3, the head portion 44 includes a reproducing head 54 and a recording head (magnetic recording head) 58 formed in the trailing edge 42b of the slider 42 by thin film processing, and is formed as a separate-type magnetic head. The reproducing head 54 and recording head 58 are covered by a protective insulating film 76 except the portion exposed to the ABS 43 of the slider 42. The protective insulating film 76 constitutes an outline of the head portion 44.

The reproducing head 54 comprises a magnetic film 55 exhibiting a magneto-resistance effect, and shield films 56 and 57 respectively disposed on the trailing side and leading side of the magnetic film 55 so as to interpose the magnetic film 55 therebetween. Lower ends of the magnetic film 55, the shield films 56 and 57 are exposed to the ABS 43 of the slider 42. The recording head 58 is provided on a trailing edge 42b side of the slider 42 with respect to the reproducing head 54.

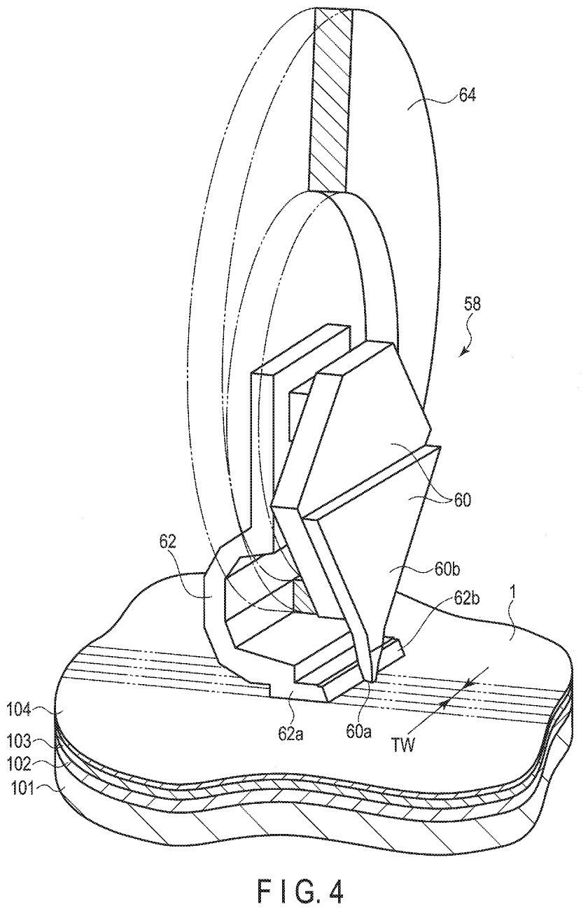

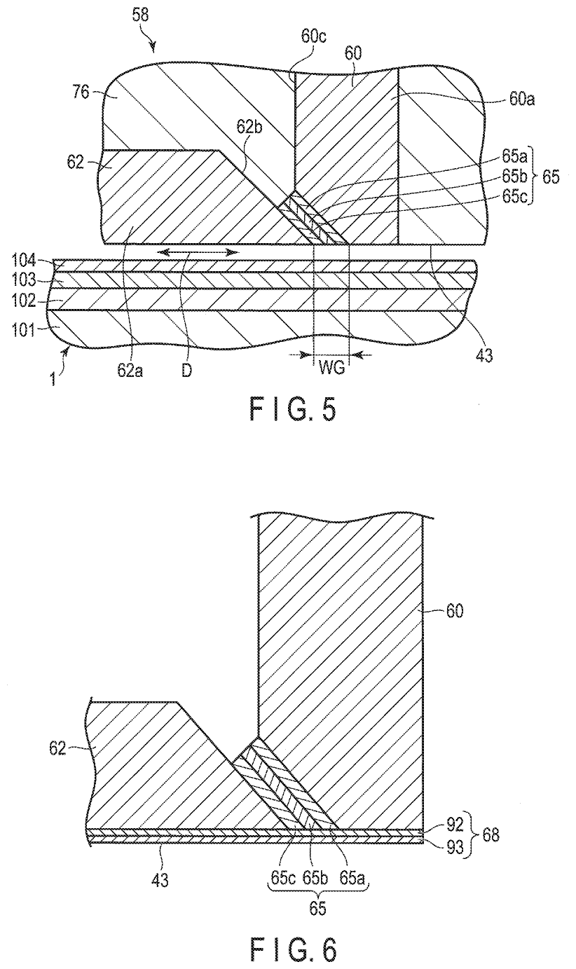

FIG. 4 is a perspective diagram schematically showing the recording head 58 and the magnetic disk. FIG. 5 is an enlarged cross section showing a magnetic disk 1-side end portion of the recording head 58, taken along a track center. FIG. 6 is a partially enlarged cross section of the magnetic head 58 shown in FIG. 5.

As shown in FIGS. 3 to 5, the recording head 58 comprises a main pole 60 made of a high saturation magnetization material which produces a recording magnetic field perpendicular to the surface of the magnetic disk 1, a trailing shield (auxiliary pole) 62 of a soft magnetic material, provided on the trailing side of the main pole 60 so as to efficiently close a magnetic path via a soft magnetic layer 102 immediately under the main pole 60, a recording coil 64 disposed to be wound around the magnetic core (magnetic circuit) including the main pole 60 and the trailing shield 62 so as to allow magnetic flux flow to the main pole 60 when writing signals on the magnetic disk 1 and a magnetic flux control layer 65 disposed to be flush with the ABS 43 between an ABS 43-side distal end portion 60a of the main pole 60 and the trailing shield 62.

The main pole 60 formed of a soft magnetic material extends substantially perpendicular to the surface of the magnetic disk 1 and the ABS 43. An ABS 43-side lower end portion of the main pole 60 includes a narrowed portion 60b narrowed down in a track width direction into a funnel shape tapered down towards the ABS 43 and a distal end portion 60a extending from the narrowed portion 60b towards the magnetic disk side. A tip end of the distal end portion 60a, that is, a lower end thereof, is exposed to the ABS 43 of the magnetic head. The width of the distal end portion 60a taken along the track-width direction substantially corresponds to a width TW of the track in the magnetic disk 1. The main pole 60 includes a shield-side edge surface 60c extending substantially perpendicular to the ABS 43 and facing the trailing side. For example, an ABS 43-side edge of the shield-side edge surface 60c extends to be inclined towards the shield side (trailing side) with respect to the ABS 43.

The trailing shield 62 formed of a soft magnetic material is formed into substantially an L-shape. The trailing shield 62 includes a distal end portion 62a opposing the distal end portion 60a of the main pole 60 with a write gap WG therebetween and a connection portion (back gap portion) 50 separate from the ABS 43 but connected to the main pole 60. The connection portion 50 is connected via a non-electric conductor 52 to an upper portion of the main pole 60, that is, an upper portion away from the ABS 43 backwards or upwards.

The distal end portion 62a of the trailing shield 62 is formed into a slim rectangular shape. The lower end surface of the trailing shield 62 is exposed to the ABS 43 of the slider 42. The leading-side edge surface (main pole-side edge surface) 62b of the distal end portion 62a extends along the width direction of the track of the magnetic disk 1 and is inclined toward the trailing side to the ABS 43. The leading-side edge surface 62b opposes substantially parallel to the shield-side edge surface 60c of the main pole 60 with a write gap WG therebetween in the lower end portion of the main pole 60 (a part of each of the distal end portion 60a and the narrowing part 60a).

As shown in FIG. 5, the magnetic flux control layer 65 has a function to suppress only the inflow of magnetic flux from the main pole 60 to the trailing shield 62, that is, to oscillate the spin torque so that the magnetic permeability of the write gap WG is becomes effectively negative.

Specifically, the magnetic flux control layer 65 includes a conductive intermediate layer (a first nonmagnetic conducting layer) 65a, an adjusting layer 65b and an electro-conductive conduction cap layer (a second nonmagnetic conductive layer) 65c, which are laminated in the order from a main pole 60 side to a trailing shield 62 side, that is, laminated in the order along a running direction D of the magnetic head. The intermediate layer 65a, the adjusting layer 65b and the conduction cap layer 65c each comprise a film surface parallel to the shield-side edge surface 60c of the main pole 60, that is, expanding along a direction intersecting the ABS 43.

Note that the laminating direction of the intermediate layer 65a, the adjusting layer 65b and the conduction cap layer 65c is not limited to that described above, but they may be laminated reversely, that is, from the trailing shield 62 side to the main pole 60 side.

Further, as shown in FIG. 6, a protective layer 68 is provided on the ABS 43 of the recording head 58, which includes the main pole 60, the magnetic flux control layer 65 and the trailing shield 62.

The intermediate layer 65a can be formed from a metal layer of, for example, a material such as Cu, Au, Ag, Al, Ir or a NiAl alloy, and which does not disturb spin conduction. The intermediate layer 65a is formed directly on the shield-side edge surface 60c of the main pole 60. The adjusting layer 65b includes a magnetic material containing at least a material of iron, cobalt or Ni. For example, the adjusting layer can be at least a material of an alloy material obtained by adding at least a material of Al, Ge, Si, Ga, B, C, Se, Sn or Ni to FeCo, or a material of an artificial lattice group such as Fe/Co, Fe/Ni and Co/Ni. The thickness of the adjusting layer may be, for example, 2 nm to 20 nm. A usable example of the material for the conduction cap layer 65c is a nonmagnetic metal which shuts off spin conduction. The conduction cap layer 65c can be formed of, for example, at least a material of Ta, Ru, Pt, W, Mo or Ir, or an alloy containing at least one of these. The conduction cap layer 65c is formed directly on the leading-side edge surface 62b of the trailing shield 62. Further, the conduction cap layer can be formed into a single- or multi-layer.

The intermediate layer 65a is formed to have a thickness of such a degree that can transmit the spin torque from the main pole 60 and also the exchange interaction effect is sufficiently weak, that is, for example, a thickness of 1 nm to 5 nm. It suffices if the conduction cap layer 65c has a thickness of such a degree that shuts off the spin torque from the trailing shield 62 and the exchange interaction is sufficiently weak, that is, for example, a thickness of 1 nm or greater.

It is necessary for the adjusting layer 65b to reverse the direction of magnetization from that of the magnetic field by the spin torque from the main pole 60, and therefore the saturation magnetic flux density of the adjusting layer 65b can be low as possible. On the other hand, in order to effectively shut off the magnetic flux by the adjusting layer 65b, the saturation magnetic flux density of the adjusting layer 65b can be high as possible. Here, the magnetic field between write gaps WG is about 10 kOe to 15 kOe; therefore it is difficult to improve the enhancing effect if the saturation magnetic flux density of the adjusting layer 65b is about 1.5 T or higher. In view of these, it is desirable to set the saturation magnetic flux density of the adjusting layer 65b to 1.5 T or less, and more specifically, the adjusting layer 65b should preferably formed such that a product of the thickness of adjusting layer 65b and the saturation magnetic flux density is 20 nmT or less.

In order to concentrate the current flowing in a direction perpendicular to the film surfaces of the intermediate layer 65a, the adjusting layer 65b and the conduction cap layer 65c, the surroundings of the magnetic flux control layer 65 are covered by an insulating layer, for example, a protective insulating film 76 except a part brought into contact with the main pole 60 and the trailing shield 62.

The main pole 60 can be formed of a soft magnetic metal alloy whose main component is an Fe—Co alloy. The main pole 60 also has a function as an electrode to apply current to the intermediate layer 65a. The trailing shield 62 can be formed of a soft magnetic metal alloy whose main component is an Fe—Co alloy. The trailing shield 62 also has a function as an electrode to apply current to the conduction cap layer 65c.

The protective layer 68 is provided to protect the ABS and formed from one or two or more materials to have a multi-layered structure. At least one material has a thermal conductivity of 200 W/(m·K) or higher. The multilayered protective layer 68 includes, for example, a first protective layer 92 provided on the ABS 43 of the recording head 58, as a thermal conductive protective layer, and a second protective layer 93 provided on the first protective layer 92 as a surface-protecting layer.

Alternatively, an underlayer (not shown) formed of, for example, Si may be provided between the ABS 43 of the recording head 58 and the multilayered protective layer 68.

A multi-layered protective layer used for the embodiment will now be further described.

(Multilayered Protective Layer 1)

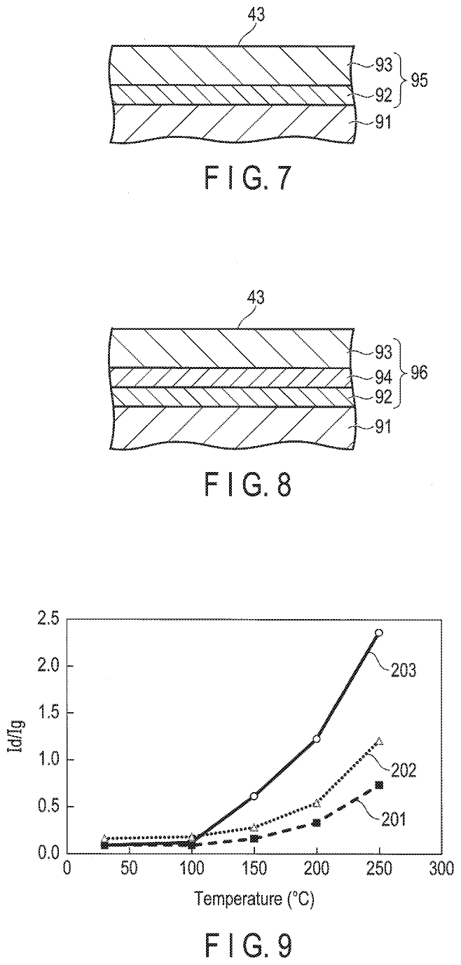

FIG. 7 is a cross section of an example of the multi-layered protective layer used for the embodiment.

As shown, a multi-layered protective layer 95 of the magnetic head slider of the embodiment comprises a first protective layer 92 and a second protective layer 93 provided in this order an air bearing surface 43 side of the slider body 91.

An example of the first protective layer 92 is a layer containing aluminum nitride.

Alternatively, in place of the layer containing aluminum nitride, a metal fine grain-containing layer can be used. The metal fine grain-containing layer contains metal fine grains and an additional material mixed with the metal fine grains. The metal fine grains contains at least a metal of silver, copper and aluminum. The additional material contains at least a material of silicon, carbon or silicon carbide.

Silver, copper or aluminum is known as metal having high thermal conductivity, and for example, the thermal conductivity of silver is 428 W/(m·K), that of copper is 400 W/(m·K), that of aluminum is 236 W/(m·K). Further, the thermal conductivity of AlN is 285 W/(m·K).

The second protective layer 93 is formed of a material different from that of the first protective layer 92, and, for example, a carbon such as diamond-like carbon or the like can be used.

The thickness of the first protective layer may be, for example, 0.5 nm to 1.5 nm. If less than 0.5 nm, the heat conduction tends to be insufficient, whereas when exceeding 1.5 nm, the thickness of the overall protective layer is influenced, thereby making a tendency of deteriorating the recording/reproducing characteristics.

The thickness of the second protective layer may be, for example, 1.0 nm to 2.0 nm. when less than 1.0 nm, there is tendency of deteriorating coating properties, whereas when exceeding 2.0 nm, the thickness of the overall protective layer is influenced, thereby making a tendency of deteriorating the recording/reproducing characteristics.

The thickness of the entire multi-layered protective layer including the first protective layer and the second protective layer may be 1.5 nm to 3.5 nm.

When less than 1.5 nm, the coating properties cannot be maintained and there is a tendency that the functions as a protective layer degraded, whereas when exceeding 3.5 nm, there is a tendency of deteriorating the recording/reproducing characteristics.

(Multilayered Protective Layer 2)

FIG. 8 is a cross section of another example of a multilayered protective layer used for the magnetic head slider of the embodiment.

As shown, a multilayered protective layer 96 of the head slider has a configuration similar to that of the protective layer 95 shown in FIG. 1 except that a contact layer 94 is further provided between the first protective layer 92 and second protective layer 93. For the contact layer 94, for example, silicon or the like can be used.

With use of the first and second multi-layered protection films, heat generated by, for example, a first heater 76a and a second heater 76b or the like, which will be described later, when recording or reproducing, can be released via the thermally-conductive first protective layer 92. Thereby, the degrading of the protective layers and the degrading of the magnetic recording/reproducing element are suppressed, making it possible to maintain the good durability of the magnetic head.

A further underlayer can be further provided between the main pole 60 and the intermediate layer 65a.

For the underlayer, for example, a metal such as Ta or Ru can be used. The thickness of the underlayer may be, for example, 0.5 nm to 10 nm. Alternatively, it may be about 2 nm.

Furthermore, a cap layer can be further provided between the trailing shield 62 and the conduction cap layer 65c.

For the cap layer, at least one kind of nonmagnetic element selected from the group consisting of Cu, Ru, W and Ta can be used. The thickness of the cap layer may be, for example, 0.5 nm to 10 nm. Alternatively, it may be about 2 nm.

Further, CoFe can be used as a spin polarization layer between the main pole and the intermediate layer.

As shown in FIG. 3, the main pole 60 and the trailing shield 62 are connected to a connecting terminal 45 via wiring lines 66, respectively, and further connected to the head amplifier IC 11 of the FIG. 1 and the HDC 13 via the wiring member (flexure) 35 shown in FIG. 2. Thus, a current circuit is formed to allow an STO drive current (bias voltage) via the main pole 60, the STO 65, the trailing shield 62 in series from the head amplifier IC.

A recording coil 64 is connected to the connecting terminal 45 via a wiring wire 77, and is further connected to the head amplifier IC 11 via the flexure 35. When writing a signal on the magnetic disk 12, a recording current is applied to the recording coil 64 from a recording current-supply circuit (not shown) of the head amplifier IC 11, and thus the main pole 60 is activated to allow a magnetic flux to flow to the main pole 60. The recording current to be supplied to the recording coil 64 is controlled by the HDC 13.

According to the HDD configured as above, the VCM 4 is driven to rotate the actuator 3, and the magnetic head 10 is moved to above a desired track of the magnetic disk 1 to be positioned. Further, as shown in FIG. 2, the magnetic head 10 flies by air stream C created between the disk surface and the ABS 4 by the rotation of the magnetic disk 1. While operating the HDD, the ABS 43 of the slider 42 opposes the disk surface with a gap therebetween. In this state, recorded date is read out from the magnetic disk 1 with the reproducing head 54, and data is written thereto by the recording head 58.

The head portion 44 of the magnetic head can optionally comprise a first heater 76a and a second heater 76b. The first heater 76a is provided in the vicinity of the recording head 58, for example, the vicinities of the recording coil 64 and the main pole 60. The second heater 76b is provided in the vicinity of the read head 54. The first heater 76a and the second heater 76b each are connected to the connecting terminal 45 via a wiring line, and further connected to the head amplifier IC 11 via the flexure 35.

The first heater 76a and the second heater 76b are, for example, coils, and generate heat as a current is allowed to flow thereto so as to thermally expand the surroundings. Thus, the ABS 43 in the vicinities of the recording head 58 and the reproducing head 54 is protruded to approach the magnetic disk 1 in distance, and the flying height of the magnetic head is lowered. Thus, when drive voltage to be supplied to each of the first heater 76a and the second heater 76b is adjusted to control the heat generation amount, the flying height of the magnetic head can be controlled.

Note that as the magnetic head used in the embodiment, a magnetic head comprising a magnetic flux control layer (spin-torque assist element) used for the spin-torque assist recording system is described here, but a magnetic head used for other recording systems, that is, for example, the heat assist recording system, can be used. For example, in the case of a heat assist recording system, a magnetic flux control layer is not formed between the main pole 60 and the trailing shield 62, and as the material of the slider body, a semiconductor compound can be employed in place of Al₂O₃—TiC.

### EXAMPLES

### Example 1

A slider provided with a magnetic head having a configuration similar to that of the recording head and the reproducing head shown in FIG. 3 was prepared.

The recording head was prepared as follows.

First, on a main pole formed mainly of FeCo, layers of the blow-described materials and thicknesses were each laminated in order using DC magnetron sputtering, to prepare a first conductive layer, an adjusting layer and a second conductive layer, and thus a magnetic flux control layer 1 was obtained. As the material for the first conductive layer, the adjusting layer and the second conductive layer, the material similar to that of the intermediate layer 65a, the adjusting layer 65b and the conduction cap layer 65c shown in FIG. 6 was used.

On an air bearing surface of the slider body formed of Al₂O₃—TiC, on which the magnetic head was provided, a two-layered protective layer was formed as follows.

First, on the slider body provided with the magnetic head, an AlN layer having a high heat conductivity of 200 W/(m·K) or higher was formed as the first protective layer by sputtering method. Subsequently, a diamond-like carbon layer was formed thereon as the second protective layer by the filtered cathodic arc method. Thus, a multi-layered protective layer having a configuration similar to that shown in FIG. 7 was obtained. The thickness of the AlN layer thus formed was 1 nm, and the thickness of the diamond-like carbon layer was 1.5 nm.

When needed, a contact layer mainly made of silicon can be inserted between the AlN layer and the diamond-like carbon layer to improve the tight contact to the carbon film.

To examine the heat-resistant characteristics of the multi-layered protective layer obtained, the magnetic head slider was loaded in a constant-temperature oven which was set to various temperatures of 70° C. to 250° C. and heated therein for 30 minutes at each temperature, and then the Raman optical spectrum of the air bearing surface was measured. FIG. 9 is a graph representing the relationship between the heating temperature and the ratio (Id/Ig) of the Raman optical spectrum of a peak intensity (Ig) of 1,500 cm⁻¹ to 1,600 cm⁻¹ to a peak intensity (Id) of 1,300 cm⁻¹ to 1,400 cm⁻¹. In the graph, a line 201 represents results of Example 1.

As Comparative Example 1, the Raman optical spectrum was measured in a manner similar to that of Example 1 wherein a protective layer was formed, except that an AlN layer was not formed. Results of Comparative Example 1 were indicated by a line 203.

When beyond 150° C., the diamond-like carbon is progressively transformed to graphite, and the properties of the film as the protective layer tend to deteriorate. Here, the value of Id/Ig increases. As shown, in the protective layer of Comparative Example 1, when exceeding 150° C., the Id/Ig increases and the degradation progresses and the heat-proof characteristics deteriorates. On the other hand, in the multilayered protective film of Example 1, the increase in Id/Ig is moderate even if exceeding 150° C., and therefore the conversion into graphite can be suppressed, making it possible to maintain excellent heat-proof characteristics.

The slider in which a multi-layered protective layer of Example 1 was formed was incorporated in a magnetic disc device for the test, and recording and reproducing were repeated in a constant-temperature oven set at a high-temperature (60° C.) for one month, but deterioration was not found in the recording/reproducing characteristics.

### Example 2

First, on the slider body provided with a magnetic head, a carbon protective layer containing Al fine grains having high thermal conductivity was formed by the filtered cathodic arc method as the first protective layer. Subsequently, a diamond-like carbon layer was formed thereon by the filtered cathodic arc method as the second protective layer. Thus, a multi-layered protective layer having a configuration similar to that of FIG. 7 was obtained.

The thickness of the Al fine grain-containing carbon protective layer thus obtained was 1 nm, and the thickness of the diamond-like carbon layer was 1.5 nm.

The amount of addition of Al of the Al fine grain-containing carbon layer may be 10 at % (atomic percent) or less. When the amount of addition of Al exceeds 10 atomic %, the quality of the film tends to deteriorate. In Example 2, the amount of addition of Al was set to 8 atomic %.

For the multi-layered protective layer, in order to improve the tight contact of the film, a contact layer mainly containing silicon can be inserted between Al₂O₃—TiC of the slider body and the high heat conductive layer as needed. A total thickness of the protection layer can be set to 2.5 nm or less in to prevent a magnetic spacing loss.

To examine the heat-resistant characteristics of the multi-layered protective layer thus obtained, the Raman optical spectrum was measured at various temperature of 70° C. to 250° C. as in the case of Example 1. FIG. 9 is a graph representing the relationship between the heating temperature and the ratio (Id/Ig) of a peak intensity (Ig) of 1,500 cm⁻¹ to 1,600 cm⁻¹ of the Raman optical spectrum to a peak intensity (Id) of 1,300 cm⁻¹ to 1,400 cm⁻¹. In the graph, a line 202 shows results of Example 2.

As shown, in the multilayered protective layer of Example 2, the increase in Id/Ig is moderate even if exceeding 150° C. as compared to Comparative Example 1. Therefore, the conversion into graphite is suppressed, and it is found that the excellent heat-proof characteristics can be maintained. Further, as compared to Example 1, the inclination of the rise of Id/Ig is steeper in Example 2, and therefore it is considered that the thermal conductivity of the protective film of Example 2 is lower than that of Example 1.

Further, the magnetic head in which ad protective layer of Example 2 was formed was incorporated in a magnetic disc device for the test, and recording and reproducing were repeated in a constant-temperature oven set at a high-temperature (60° C.) for one month, but deterioration was not found in the recording/reproducing characteristics.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic head slider comprising:
a slider body;
a magnetic recording/reproducing element provided on the slider body;
a thermally conductive first protective layer provided on at least a part of a total of air bearing surfaces of the slider body and the magnetic recording/reproducing element, having a thermal conductivity of 200 W/(m·K) or higher; and
a second protective layer provided on the first protective layer.

2. The head slider of claim 1, wherein
the first protective layer comprises aluminum nitride.

3. The head slider of claim 1, wherein
the first protective layer contains metal fine grains of at least one of silver, copper and aluminum, and contains an additional material of silicon, carbon or silicon carbide mixed with the metal fine grains.

4. The head slider of claim 1, wherein
the second protective layer is of carbon.

5. The head slider of claim 1, further comprising a silicon-containing contact layer between the first protective layer and the second protective layer.

6. A magnetic head assembly comprising:
a magnetic head slider comprising,
a slider body,
a magnetic recording/reproducing element provided on the slider body,
a thermally conductive first protective layer provided on at least a part of a total of air bearing surfaces of the slider body and the magnetic recording/reproducing element, having a thermal conductivity of 200 W/(m·K) or higher, and
a second protective layer provided on the first protective layer;
a suspension with an end in which the magnetic head slider is mounted; and
an actuator arm connected to an other end of the suspension.

7. The head assembly of claim 6, wherein
the first protective layer contains aluminum nitride.

8. The head assembly of claim 6, wherein
the first protective layer contains metal fine grains of at least one of silver, copper and aluminum, and contains an additional material of silicon, carbon or silicon carbide mixed with the metal fine grains.

9. The head assembly of claim 6, wherein
the second protective layer is of carbon.

10. The head assembly of claim 6, further comprising a silicon-containing contact layer between the first protective layer and the second protective layer.

11. A magnetic disk device comprising:
a magnetic head assembly which comprises
a magnetic head slider comprising:
a slider body;
a magnetic recording/reproducing element provided on the slider body;
a thermally conductive first protective layer provided on at least a part of a total of air bearing surfaces of the slider body and the magnetic recording/reproducing element, having a thermal conductivity of 200 W/(m·K) or higher; and
a second protective layer provided on the first protective layer;
a suspension with an end in which the magnetic head slider is mounted; and
an actuator arm connected to an other end of the suspension.

12. The disk device of claim 11, wherein
the first protective layer contains aluminum nitride.

13. The disk device of claim 11, wherein
the first protective layer contains metal fine grains of at least one of silver, copper and aluminum, and contains an additional material of silicon, carbon or silicon carbide mixed with the metal fine grains.

14. The disk device of claim 11, wherein
the second protective layer is of carbon.

15. The disk device of claim 11, further comprising a silicon-containing contact layer between the first protective layer and the second protective layer.
